(19) United States
(12) Patent Application Publication
(10) Pub. No.: US 2018/0185124 A1
(43) Pub. Date: Jul. 5, 2018

(54) ABUTMENT ATTACHMENT

(71) Applicant: Curd GADAU, Bessenbach (DE)

(72) Inventor: Curd GADAU, Bessenbach (DE)

(21) Appl. No.: 15/523,716

(22) PCT Filed: Nov. 3, 2015
(86) PCT No.: PCT/EP2015/075539

§ 371 Date: Aug. 8, 2017

(30) Foreign Application Priority Data
Nov. 3, 2014 (DE) 10 2014 016 081.5

(51) Int. Cl. A61C 8/00

(52) U.S. Cl. CPC A61C 8/0059; A61C 8/0068; A61C 8/006; A61C 8/0069

(57) ABSTRACT

The present invention relates to an abutment attachment (100) which can be fastened on a jaw implant (101), comprising an opening (103) for inserting a fixing screw (105); and an adhesive base portion (107) for forming an adhesive base for an adhesive body (109) which is arranged laterally adjacent to the opening (103) and projects beyond the opening (103).

The present invention relates to an abutment attachment which can be fastened on a jaw implant.

DE 10 2012 106 468 A1 relates to a tooth implant construction system comprising an abutment attachment for a jaw implant, comprising a fastening portion for fastening the abutment attachment on the jaw implant; and an adhesive base, laterally offset with respect to the fastening portion, for gluing on a crown adhesive body.

The object of the present invention is to provide an abutment attachment which makes a large angular range possible for gluing an adhesive body on.

This object is achieved by subject matter in accordance with the independent claim. Advantageous embodiments form the subject matter of the dependent claims, the description and the drawings.

In a first aspect, the object is achieved by an abutment attachment which can be fastened on a jaw implant, comprising an opening for inserting a fixing screw and an adhesive base portion for forming an adhesive base for an adhesive body which is arranged laterally adjacent to the opening and projects beyond the opening. As a result of the laterally offset adhesive base, the adhesive body which is placed on may have a high slant, without going below a minimum wall thickness of the material. In addition, the laterally offset adhesive base portion does not obstruct insertion of the fixing screw. The fixing screw does not need to be passed around edges within a screw channel. Nevertheless, stable fastening of the adhesive body with a large adhesive surface on the abutment attachment is achieved.

In an advantageous embodiment of the abutment attachment, the adhesive base portion extends offset in a parallel manner from a screw channel for the fixing screw. This achieves for example the technical advantage that the adhesive body can be placed on in a simple manner in the direction of the screw channel.

In a further advantageous embodiment of the abutment attachment, the adhesive base portion tapers towards the tip. This achieves for example the technical advantage that the adhesive body can be placed on without tilting.

In a further advantageous embodiment of the abutment attachment, the adhesive base portion is tongue-shaped, post-shaped or pin-shaped. This achieves for example the technical advantage that the clearance of the adhesive body can be produced in a simple manner using a drill or a cutting tool.

In a further advantageous embodiment of the abutment attachment, the adhesive base portion is formed without edges. This achieves for example the technical advantage that the gluing body is prevented from tilting when it is being placed on.

In a further advantageous embodiment of the abutment attachment, the adhesive base portion extends in an arc shape in cross section with respect to the centre of the screw channel. This achieves for example the technical advantage that a large adhesive surface is achieved and lever forces can be efficiently absorbed.

In a further advantageous embodiment of the abutment attachment, the faces of the adhesive base portion are rounded in a semi-circular shape in cross section. This achieves for example the technical advantage that the corresponding clearance in the adhesive body can be produced in a simple manner by means of a radius cutter.

In a further advantageous embodiment of the abutment attachment, the abutment attachment comprises a collar for laterally enclosing a screw head. This achieves for example the technical advantage that the adhesive surface of the adhesive base is enlarged.

In a further advantageous embodiment of the abutment attachment, the collar has a slant which is positioned opposite the adhesive base portion. This achieves for example the technical advantage that the inclination can be increased for the adhesive body and the crown.

In a further advantageous embodiment of the abutment attachment, the slant extends as far as a protruding rim for bracing the adhesive body. This achieves for example the technical advantage that inserting the fixing screw is facilitated.

In a further advantageous embodiment of the abutment attachment, the slant extends as far as the centre of the screw channel. This achieves for example the technical advantage that inserting the fixing screw is facilitated.

In a further advantageous embodiment of the abutment attachment, the collar comprises clearances for latching the adhesive body in. This achieves for example the technical advantage that the adhesive body can be fastened provisionally.

In a further advantageous embodiment of the abutment attachment, the clearances are arranged on opposite faces of the collar. This achieves for example the technical advantage that the adhesive body can be fastened provisionally at a high strength.

In a further advantageous embodiment of the abutment attachment, the collar transitions into the adhesive base portion by way of a concave clearance. This achieves for example the technical advantage that the adhesive face of the adhesive base is increased and positioning the adhesive body on the adhesive base is facilitated.

In a further advantageous embodiment of the abutment attachment, the abutment attachment comprises an adhesive base, L-shaped in cross section, comprising the adhesive base portion. This achieves for example the technical advantage that the structure has a high integral strength.

In a further advantageous embodiment of the abutment attachment, the abutment attachment comprises an adhesive base which is at an inclination to the screw channel. This achieves for example the technical advantage that the adhesive body can be placed on at an angle with respect to the screw channel and can be adapted to the spatial conditions.

Embodiments of the invention are shown in the drawings and are disclosed in greater detail in the following.

In the drawings:

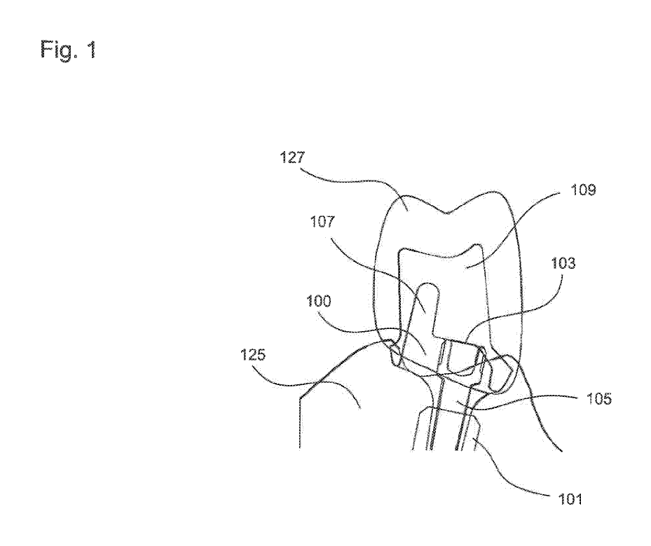

FIG. 1 is a view of the abutment attachment in an oral cavity;

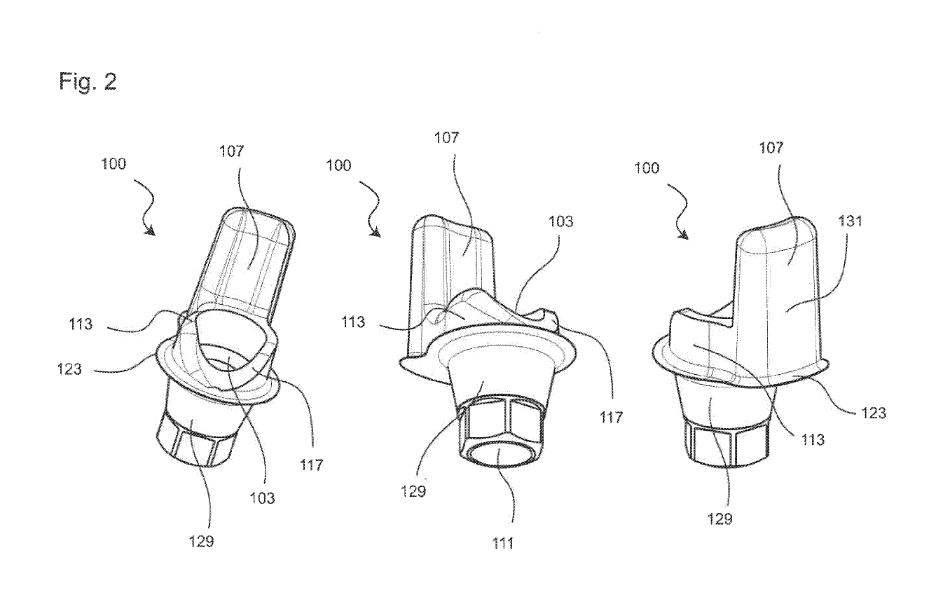

FIG. 2 gives a plurality of views of an abutment attachment;

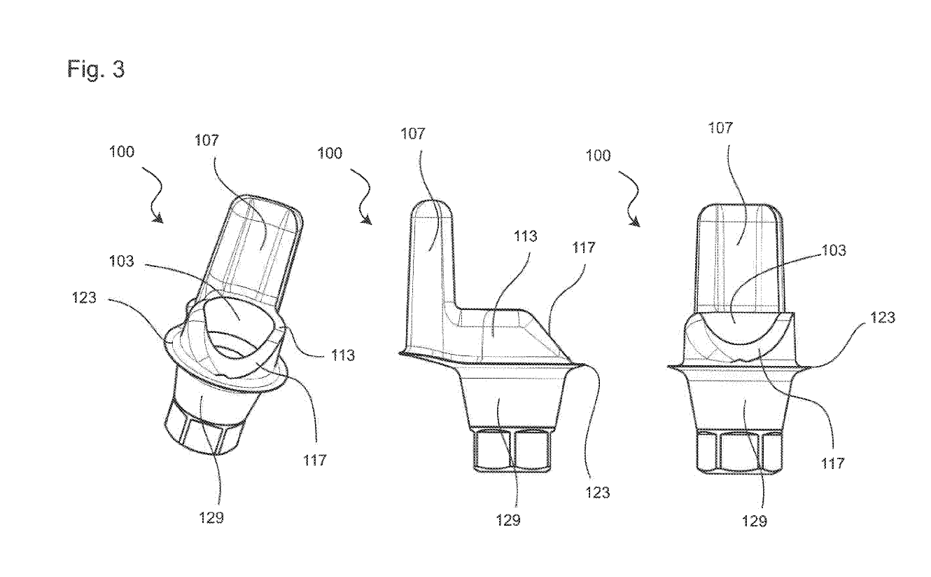

FIG. 3 gives a plurality of views of the abutment attachment;

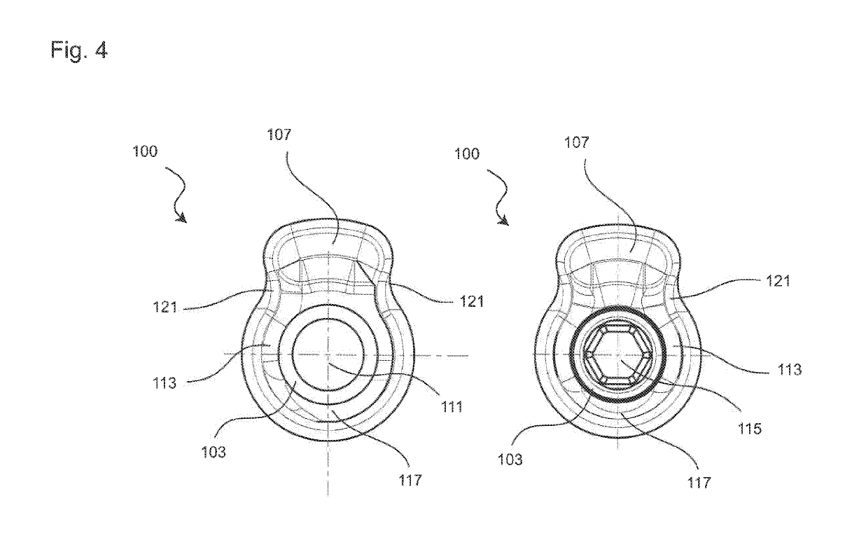

FIG. 4 gives two views of the abutment attachment;

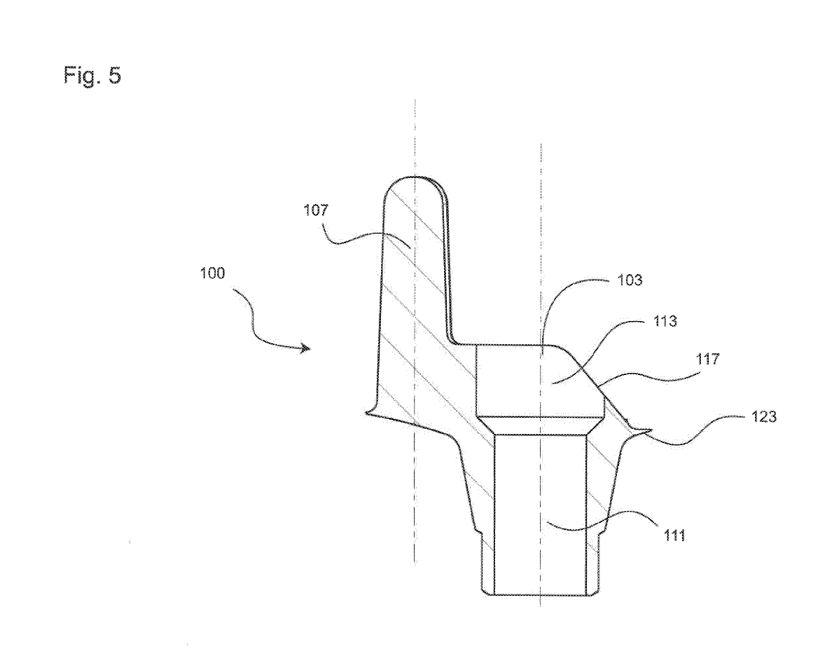

FIG. 5 is a cross-sectional view through the abutment attachment; and

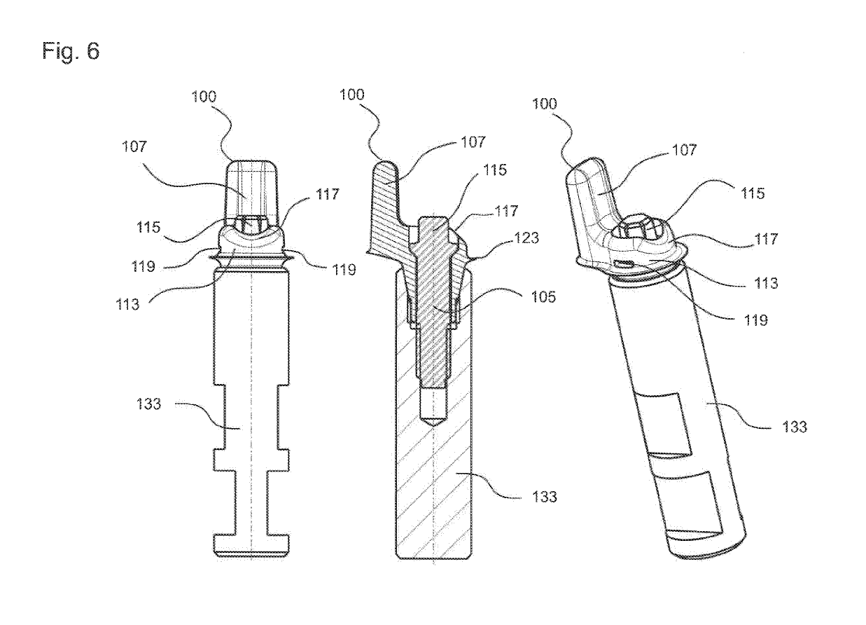

FIG. 6 gives a plurality of views of the abutment attachment in a transfer post.

FIG. 1 is a schematic view of the abutment attachment 100 in an oral cavity. The abutment attachment 100 is fastened on a jaw implant 101, and serves for placing on an adhesive body 109. In turn, the crown adhesive body 127 of a dental crown is glued onto the adhesive body 109. The adhesive body 109 is formed from a white material, such as solidly coloured zirconium or a ceramic. The white adhesive body 109 results in a more natural appearance of the denture.

The abutment attachment 100 is formed from metal in a single piece and may be coated with titanium nitride. The abutment attachment 100 is fastened on the screwed-in jaw implant 101 by means of a fixing screw 105. For this purpose, the fixing screw 105 is inserted into an opening 103 of the abutment attachment 100 and inserted into the jaw implant 101. The abutment attachment 100 comprises a laterally offset adhesive base portion 107, which protrudes alongside the opening 103. As a result of the adhesive base portion 107 arranged laterally above the opening 103, both vertical and horizontal forces can be absorbed and supported well. The overall construction is enclosed by the gum 125.

FIG. 2 and FIG. 3 give a plurality of enlarged views of an abutment attachment 100. The abutment attachment 100 is constructed with reflectional symmetry. The fixing screw 105 is inserted into the opening 103 of the abutment attachment 100 from above and slid through the cylindrical screw channel 111 into the abutment attachment 100. The entire abutment attachment 100 has for example a total height of 7.5 mm. The adhesive base portion 107 has a height of 2.5 mm on the inside and a height of 4.3 mm on the outside.

Subsequently, the fixing screw 105 is screwed into an internal thread of the jaw implant 101. As a result, the fixing screw 105 presses the abutment attachment 100 onto the jaw implant 101. On the lower face, the abutment attachment 100 comprises a conical fastening portion 129. On the lower face of the fastening portion 129, there is in turn a hexagon portion as an anti-twist device. The hexagon portion is inserted into a corresponding clearance in the jaw implant 101.

The abutment attachment 100 comprises a protruding rim 123, which peripherally braces the jaw body 109 which is placed on. The adhesive basis 131 of the abutment attachment 100 is located above the rim 123. The conical fastening portion 129 is arranged below the rim 123.

The adhesive body 109 is glued onto the surface of the adhesive base 131 using an adhesive. A screw head of the fixing screw 105 is enclosed by a collar 113 of the adhesive base 131. The collar 113 is likewise a portion of the adhesive base 131. The wall of the collar 113 likewise tapers upwards in such a way that the adhesive body can be placed on in a simple manner. The collar 113 enlarges the adhesive surface of the adhesive base 131 and protects the screw head from lateral contact with the adhesive. On the front face, the collar 113 has a slant 117 which is positioned opposite the adhesive base portion 107.

To the side of the opening 103, the adhesive base 131 comprises an adhesive base portion 107, which is arranged alongside the opening 103 and protrudes beyond the opening 103 in a tongue shape in the same direction as the screw channel 111. The adhesive base portion 107 tapers towards the tip, and is formed without corners and edges in a rounded manner. Each curve of the adhesive base 131 has a particular minimum radius of curvature, in such a way that the corresponding clearance in the adhesive body 109 can be produced using a radius cutter. The radius of curvature is for example 0.5 mm. Since the curvature corresponds to the radius of the radius cutter, this results in a uniform fit for the adhesive body 109.

The adhesive base portion 107 enlarges the surface of the adhesive base 131 upwards and ensures a high strength of the connection to the adhesive body 109. The lateral arrangement of the adhesive base portion 107 alongside the opening 103 makes it possible for the base body 109 to be formed with a large slant above the opening 103, without going below a minimum wall thickness of the adhesive body 109 above the opening 103. As a result, the adhesive body 109 and the overall construction can be better adapted to the spatial conditions within the oral cavity. The fixing screw 105 can be inserted in a simple manner into the opening 103 and the screw channel 111 positioned below. The tongue-shaped adhesive base portion 107 has for example a width of 3 mm to 6 mm.

The adhesive base portion 107 protrudes beyond the rim of the opening 103 and as part of the adhesive base 131 is arranged completely spatially separated, laterally offset alongside the opening 103. This achieves the advantage that a high offset with respect to the fastening portion 129 is produced. A screw channel 111 does not have to have an elbowed shape, and so it is not necessary to pass the fixing screw 105 around an edge within an elbowed screw channel. Fastening the abutment attachment 100 on the jaw implant 101 is thus greatly facilitated and simplified. The abutment attachment 100 has a high stability in spite of this.

FIG. 4 gives two views of the abutment attachment 100, without an inserted fixing screw 105 and with an inserted fixing screw 105. The screw head 115 of the fixing screw 105 is concentrically enclosed by the collar 113. The adhesive base portion 107 extends in an arc shape in cross section with respect to the centre of the screw channel 111. As a result, lever forces are transferred to the fastening portion 129 uniformly and the surface of the adhesive base 131 is enlarged. The faces of the adhesive base portion 107 are rounded semi-circularly in cross section. The slant 117 of the collar 113 is arranged diametrically opposite the adhesive base portion 107 with respect to the screw channel 111.

The collar 113 transitions into the adhesive base portion 107 by way of two opposing concave clearances 121. The clearances 121 result in a kidney shape of the adhesive base on both faces 131. This enlarges the adhesive surface of the adhesive base 131 and facilitates positioning the adhesive body 109 on the adhesive base 131.

FIG. 5 is a cross-sectional view through the abutment attachment 100. The tongue-shaped adhesive base portion 107 extends offset in a parallel manner from the screw channel 111 for the fixing screw 105. The offset between the screw channel 111 and the adhesive base portion 107 is for example 0.5 mm.

The slant 117 of the collar 113 extends diagonally as far as the protruding rim 123 for bracing the adhesive body 109. The slant 117 starts approximately at the centre of the screw channel 111. Overall, there is an L-shaped adhesive base 131, one limb of which is formed by the adhesive base portion 107 and the other limb of which is formed by the collar 113. The slant is by way of example at an angle of 45°. In general, however, the slant may be at an angle of 0° to 50°.

The collar 113 and the adhesive base portion 107 extend mutually perpendicular. In general, however, the collar 113 and the adhesive base portion 107 may also be at any other angle to one another. In addition, the entire adhesive base 131 comprising the protruding adhesive base portion 107 and the collar 113 may be at an inclination to the screw channel 101 at an angle of −30° to +30°. This inclination involves both the adhesive base portion 107 and the collar 113 being at an inclination, in such a way that the perpendicular angle between the adhesive base portion 107 and the collar 113 is maintained. The shape of the adhesive base 131 is thus substantially maintained.

The edge between the collar 113 and the adhesive base portion 107 is formed rounded, in such a way that the corresponding point in the adhesive body 109 can be produced using a radius cutter. In addition, this increases the break strength of the connection.

FIG. 6 gives a plurality of views of the abutment attachment 100 in a transfer post 133. The transfer post 133 serves to reproduce the spatial relationships of the jaw implant 101 in a plaster model. Part of the fixing screw 115 protrudes from the opening 103.

On the side, the collar 113 comprises elongate clearances 119 for latching the adhesive body 109 in. The clearances 119 are arranged on opposite faces of the collar 113 above the rim 123. The clearances 119 are positioned diametrically opposite on the screw channel 111. Correspondingly arranged projections, arranged inside the clearance of the adhesive body 109, engage in the clearances 119, making provisional fastening of the adhesive body 109 on the adhesive base 131 possible by placing it on.

All features described and shown in connection with individual embodiments of the invention may be provided in a different combination in the subject matter according to the invention, so as to implement the advantageous effects thereof simultaneously.

The scope of protection of the present invention is defined by the claims, and is not limited by the features described in the description or shown in the drawings.

### REFERENCE NUMERALS

100 Abutment attachment
101 Jaw implant
103 Opening
105 Fixing screw
107 Adhesive base portion
109 Adhesive body
111 Screw channel
113 Collar
115 Screw head
117 Slant
119 Clearances
121 Clearance
123 Rim
125 Gum
127 Crown adhesive body
129 Fastening portion
131 Adhesive base
133 Transfer post

1. Abutment attachment which can be fastened on a jaw implant, comprising:
an opening for inserting a fixing screw which extends from said jaw implant; and
an adhesive base portion for forming an adhesive base for an adhesive body which is arranged laterally adjacent to the opening and projects beyond the opening.

2. Abutment attachment according to claim 1, wherein the adhesive base portion extends offset in a parallel manner from a screw channel for the fixing screw.

3. Abutment attachment according to claim 1, wherein the adhesive base portion tapers towards the tip.

4. Abutment attachment according to claim 1, wherein the adhesive base portion is tongue-shaped, post-shaped or pin-shaped.

5. Abutment attachment according to claim 1, wherein the adhesive base portion is formed without edges.

6. Abutment attachment according to claim 1, wherein the adhesive base portion extends in an arc shape in cross section with respect to the centre of the screw channel.

7. Abutment attachment according to claim 1, wherein the faces of the adhesive base portion are rounded substantially semi-circularly in cross section.

8. Abutment attachment according to claim 1, wherein the abutment attachment comprises a collar for laterally enclosing a screw head.

9. Abutment attachment according to claim 8, wherein the collar has a slant which is positioned opposite the adhesive base portion (107).

10. Abutment attachment according to claim 9, wherein the slant extends as far as a protruding rim for bracing the adhesive body.

11. Abutment attachment according to claim 9, wherein the slant extends as far as a centre of the screw channel.

12. Abutment attachment according to claim 8, wherein the collar comprises clearances for latching the adhesive body in.

13. Abutment attachment according to claim 12, wherein the clearances are arranged on opposite faces of the collar.

14. Abutment attachment according to claim 8, wherein the collar transitions into the adhesive base portion by way of a concave clearance.

15. Abutment attachment according to claim 1, wherein the abutment attachment comprises an adhesive base, L-shaped in cross section, comprising the adhesive base portion.

16. Abutment attachment according to claim 1, wherein the abutment attachment comprises an adhesive base which is at an inclination to the screw channel.
